(19) United States
(12) Patent Application Publication
(10) Pub. No.: US 2025/0156131 A1
(43) Pub. Date: May 15, 2025

(54) IMAGE FORMING APPARATUS AND METHOD OF CONTROLLING IMAGE FORMING APPARATUS

(71) Applicant: SHARP KABUSHIKI KAISHA, Osaka (JP)

(72) Inventor: KENTO WASHIDA, Osaka (JP)

(21) Appl. No.: 18/944,350

(22) Filed: Nov. 12, 2024

(30) Foreign Application Priority Data
Nov. 14, 2023 (JP) 2023-193686

(51) Int. Cl. G06F 3/12

(52) U.S. Cl. CPC G06F 3/1273; G06F 3/1205; G06F 3/1274; G06F 3/1285

(57) ABSTRACT

An image forming apparatus including a display; and one or more controllers, wherein the one or more controllers refer to first information associating user identification information identifying a user with print history information indicating presence or absence of print histories related to print jobs held by the image forming apparatus, and control, on a basis of whether the print history information corresponding to the user identification information of a logged-in user who is logged in to the image forming apparatus indicates the presence of a print history of some of the print jobs, whether to cause a first confirmation screen including information indicating at least one print job other the some of the print jobs to appear on the display.

### CROSS-REFERENCE TO RELATED APPLICATION

The present application claims priority from Japanese Application JP 2023-193686, the content of which is hereby incorporated by reference into this application.

### BACKGROUND OF THE INVENTION

### Field of the Invention

The disclosure related to an image forming apparatus and a method of controlling the image forming apparatus.

### Description of the Related Art

For example, the image forming apparatus holds a print job based on a user operation and executes the held print job after the user has logged in to the image forming apparatus. As a related technique, a technique of displaying a print all button for executing all print jobs associated with a logged-in user at the top of a home screen has been known in the related art.

For example, it is assumed that an image forming apparatus holds multiple print jobs associated with a user on the basis of a user operation. Here, the user may log in to the image forming apparatus with the intention of executing not all of the print jobs but some of the print jobs. In this case, according to the related technique, all the print jobs associated with the logged-in user are executed on the basis of the operation on the print all button, and thus a some of the print jobs intended by the user cannot be executed.

In a case where the above-described print all button is not used, in order to execute some print jobs intended for printing, the user needs to search for and select some print jobs intended as print targets by the user one by one from multiple print jobs associated with the logged-in user. In this case, the selection operation for selecting the print targets becomes complicated.

An object of an aspect of the disclosure is to provide an image forming apparatus and the like capable of presenting a print job to be a print target to a user.

### SUMMARY OF THE INVENTION

An image forming apparatus comprising a display; and one or more controllers, wherein the one or more controllers refer to first information associating user identification information identifying a user with print history information indicating presence or absence of print histories related to print jobs held by the image forming apparatus, and control, on a basis of whether the print history information corresponding to the user identification information of a logged-in user who is logged in to the image forming apparatus indicates the presence of a print history of some of the print jobs, whether to cause a first confirmation screen including information indicating at least one print job other the some of the print jobs to appear on the display.

According to the disclosure, it is possible to provide an image forming apparatus and the like capable of presenting a print job to be a print target to a user.

### BRIEF DESCRIPTION OF THE DRAWINGS

FIG. 1 illustrates an example of an image forming apparatus.

FIG. 2 illustrates an example of a held job table.

FIG. 3 is a flowchart illustrating an example of a processing flow according to an embodiment.

FIG. 4 illustrates an example of a basic screen.

FIG. 5 is a first flowchart continued from FIG. 3.

FIG. 6 illustrates an example of a first confirmation screen.

FIG. 7 illustrates an example of a deletion confirmation screen.

FIG. 8 illustrates an example of a held job screen.

FIG. 9 is a second flowchart continued from FIG. 3.

FIG. 10 is a flowchart illustrating an example of a job extraction process.

FIG. 11 illustrates an example of a second confirmation screen.

FIG. 12 is a third flowchart continued from FIG. 3.

FIG. 13 illustrates an example of a third confirmation screen.

### DETAILED DESCRIPTION OF THE INVENTION

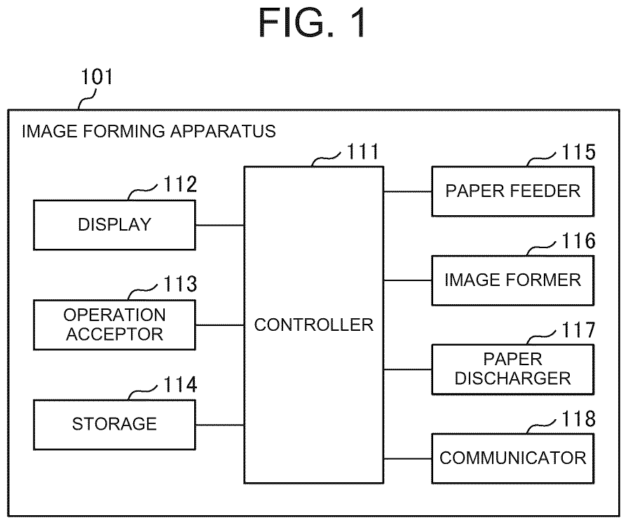

Embodiments will be described below. FIG. 1 illustrates an example of an image forming apparatus 101. The image forming apparatus 101 includes a controller 111, a display 112, an operation acceptor 113, a storage 114, a paper feeder 115, an image former 116, a paper discharger 117, and a communicator 118. The configuration of the image forming apparatus 101 is not limited to the example of FIG. 1.

The controller 111 comprehensively controls the image forming apparatus 101. Details of each processes executed by the controller 111 will be described later. The controller 111 includes at least one processor and at least one memory. The execution of multiple instruction sets (programs) stored in the memory by the processor of the controller 111 can achieve various kinds of control of the embodiments. As the processor, any processor may be used, such as a central processing unit (CPU), a graphics processing unit (GPU), or a field programmable gate array (FPGA).

The programs described above are stored in a non-transitory recording medium, such as a semiconductor medium, an optical recording medium, or a magneto-optical recording medium. The processor of the controller 111 then executes the programs stored in the recording medium to achieve the various kinds of control according to the present embodiment. The image forming apparatus 101 may acquire the above-described programs from an external server via a network.

The display 112 displays various types of information on the basis of the control of the controller 111. The information is, for example, each screen described later. The operation acceptor 113 accepts an operation of the user. The user is a user who logs in to the image forming apparatus 101. The display 112 and the operation acceptor 113 may be, for example, an integrated touch panel display.

The storage 114 stores various types of information. The storage 114 stores, for example, a held job table to be described later. The paper feeder 115 is a paper feeding mechanism for feeding paper, and operates on the basis of the control of the controller 111. The image former 116 forms an image on a fed sheet on the basis of the control of the controller 111. The paper discharger 117 discharges the sheet on which the image is formed.

The communicator 118 communicates with external devices. For example, when an external computer used by a user is connected to the image forming apparatus 101, the communicator 118 communicates with this external computer. The number of external computers may be one or more. For example, when each user performs a print operation by using a corresponding external computer, the external computer transmits a print job to the image forming apparatus 101. The communicator 118 receives the print job transmitted from the external computer.

In the present embodiment, upon receiving a print job based on a user operation, the image forming apparatus 101 stores the received print job in, for example, the storage 114. This causes the print job based on the user operation to be held in the image forming apparatus 101. The print job held by the image forming apparatus 101 may be hereinafter referred to as a held job.

For example, when a user performs a print operation by using an external computer, the external computer transmits a print job associated with a user name for identifying the user to the image forming apparatus 101. The image forming apparatus 101 receives print jobs from multiple users. In such a case, the image forming apparatus 101 holds print jobs of the multiple users. In the present embodiment, the controller 111 of the image forming apparatus 101 refers to a held job table stored in the storage 114 and performs execution control of the print jobs of the respective users. Details of the held job table will be described later.

The controller 111 refers to the held job table and recognizes each print job corresponding to the logged-in user among the held jobs. When it is indicated that some of the print jobs corresponding to the logged-in user have been executed in the past, the controller 111 causes the display 112 to display the first confirmation screen including information indicating at least one print job other than the some of the print jobs. Some print jobs indicating that they have been executed in the past are, for example, resident jobs. At least one of the print jobs other than the some of the print jobs is, for example, a print job of a table, a document, or the like.

The image forming apparatus 101 according to the present embodiment basically deletes an executed print job after the print job is executed. However, the image forming apparatus 101 according to the present embodiment does not delete some print jobs (for example, resident jobs) among the held jobs after printing is executed.

The resident jobs are not deleted after printing is executed. Therefore, the resident jobs are print jobs that have been printed in the past. For example, since a resident job is periodically and automatically executed, it can be estimated that the possibility that the logged-in user performs a login operation to execute printing is low. That is, it is estimated that there is a high possibility that a resident job is a print job that the logged-in user does not intend to print.

On the other hand, print jobs (print jobs that have not been executed in the past) other than some print jobs executed in the past among the held jobs are print jobs newly added by the logged-in user. As described above, a newly added print job is, for example, a print job of a table, a document, or the like.

It can be estimated that such a newly added print job other than a resident job is highly likely to be printed by the logged-in user performing a login operation. That is, it can be estimated that there is a high possibility that the newly added print job is a print job that the logged-in user intends to print.

The controller 111 refers to the held job table and causes the display 112 to display the first confirmation screen including information indicating at least one print job other than some print jobs executed in the past among the held jobs corresponding to the logged-in user. This makes it possible to present a print job (for example, a newly added print job) that is highly likely to have been intended to be printed by the logged-in user. Each process of the present embodiment using the held job table will be explained below.

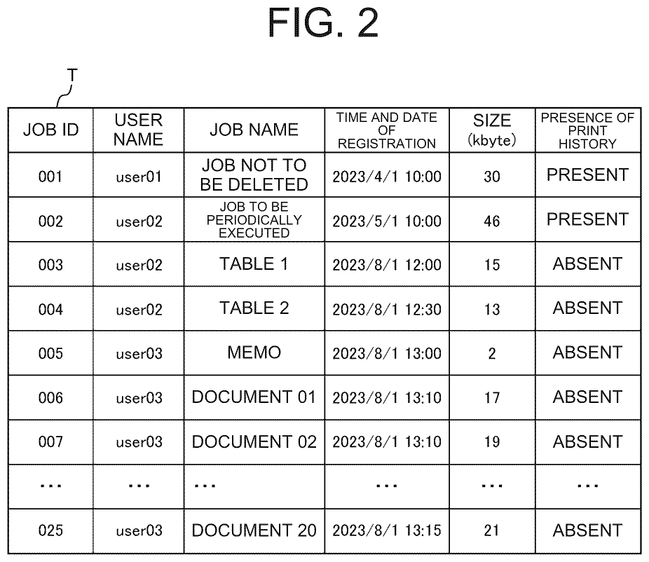

A held job table T will be described. FIG. 2 illustrates an example of the held job table T. In the present embodiment, the held job table T is stored in the storage 114. However, the held job table T may be stored in a computer (for example, a server) different from the image forming apparatus 101. In this case, the image forming apparatus 101 acquires the held job table T stored in the server from the server and performs the processing of the present embodiment.

The held job table T is first information including items of job ID, user name, job name, registration date and time, size, and the presence or absence of print history. The configuration of the held job table T is not limited to the example of FIG. 2.

The job ID, the user name, the job name, the registration date and time, the size, and the presence or absence of print history are associated with each other. The job ID is an ID for identifying a print job. For example, the controller 111 may assign a different job ID to each print job in the order of reception by the image forming apparatus 101.

The user name is user identification information for identifying a user included in a print job. The user identification information may be, for example, a user ID. For example, when a user performs a printing operation using an external computer, the user inputs the user identification information to the external computer. Accordingly, the external computer may include the user identification information (information of the user name) in the print job. The controller 111 may record information in the item of the user name in the held job table T on the basis of the information of the user name included in the print job.

A job name represents the name of a print job. Information of the job name is also included in the print job. The information of the job name may be added by the external computer on the basis of a print operation by the user. The controller 111 records the information of the job name included in the print job in the item of the job name in the held job table T.

The registration date and time represents the date and time when the image forming apparatus 101 received and registered the print job. For example, the controller 111 records the information of the date and time when the image forming apparatus 101 received and registered the print job in the item of the registration date and time of the held job table T.

The size represents a file size (size) of the print job. The print job is a job for printing a file instructed to be printed by the user. Information of the file size is included in the print job. For example, the controller 111 may record the information of the file size included in the print job received by the image forming apparatus 101 in the item of the size of the held job table T.

The presence or absence of print history is information indicating whether or not each job held by the image forming apparatus 101 has been executed in the past. As described above, the controller 111 basically deletes the executed print job after printing is executed. In this case, the controller 111 deletes information (each piece of information corresponding to a job ID) indicating a print job corresponding to the executed print job among the held job table T.

On the other hand, as described above, the held jobs include some print jobs (for example, resident jobs) that are not deleted after printing is executed. A resident job, for example, is a print job to be periodically executed (periodically executed job) or a print job that is set not to be deleted after printing (target job not be deleted) is executed. For example, it is assumed that a user performs a print operation involving setting of a job to be periodically executed, a job not to be deleted, or the like by using an external computer. In this case, the print job includes information on the setting of a job to be periodically executed, a job not to be deleted, or the like.

The controller 111 recognizes, as a resident job, a print job set not to be deleted after printing is executed, such as a job to be periodically executed, a job not to be deleted, and the like. When a resident job is executed, the controller 111 changes the item of the presence or absence of print history in the held job table T from “absence” to “presence” without deleting the information of the executed resident job. The print job corresponding to “presence” in the item of the presence or absence of print history indicates that the print job has been executed in the past.

For example, it is assumed that when a user (user name “user01”) performs a print operation by using an external computer, the user performs an operation for setting not to delete a print job after the print job is executed. In this case, the print job includes information indicating the setting.

The controller 111 recognizes that the print job is a resident job on the basis of the information indicating the setting. The resident job is not deleted even if it is executed. Here, in the held job table T illustrated in the example of FIG. 2, the print job corresponding to the user name “user01” is the print job of the job ID “001.”

After the print job (resident job) of the job ID “001,” the controller 111 changes the item of the presence or absence of the print history corresponding to the executed resident job in the held job table T from “absence” to “presence.”

Next, a case where a user (user name “user02”) performs print operations of three print jobs by using an external computer will be described. It is assumed that, when the user performs a printing operation for one of the three print jobs, the user established a setting to periodically perform printing (for example, to perform printing every Monday).

In the example of FIG. 2, the print job of the job ID “002” (the job name is “periodically executed job”) is a job for which a setting for periodically executing printing has been established by the user of the user name “user02.” After executing the print job of the job ID “002,” the controller 111 changes the presence/absence of the print history corresponding to the job ID “002” from “absence” to “presence” without deleting the print job.

It is assumed that the user (user name “user02”) performs an operation of printing “Table 1” and “Table 2” by using the external computer. The print jobs of “Table 1” and “Table 2” are the remaining two print jobs of the three print jobs. It is assumed that the two print jobs are not set not to be deleted after printing is executed.

After the image forming apparatus 101 receives the two print jobs of “Table 1” and “Table 2,” the controller 111 holds the two print jobs. The controller 111 adds the job ID “003” to the print job of “Table 1” and records each piece of information of the print job in the held job table T. The controller 111 adds the job ID “004” to the print job of “Table 2” and records each piece of information of the print job in the held job table T.

After the user name “user02” logs in to the image forming apparatus 101, information indicating the print jobs of “Table 1” and “Table 2” is displayed on the display 112. When a print operation is performed on each screen to be described later, the controller 111 executes print jobs of “Table 1” and “Table 2.” The controller 111 deletes the information of the job IDs “003” and “004” from the held job table T.

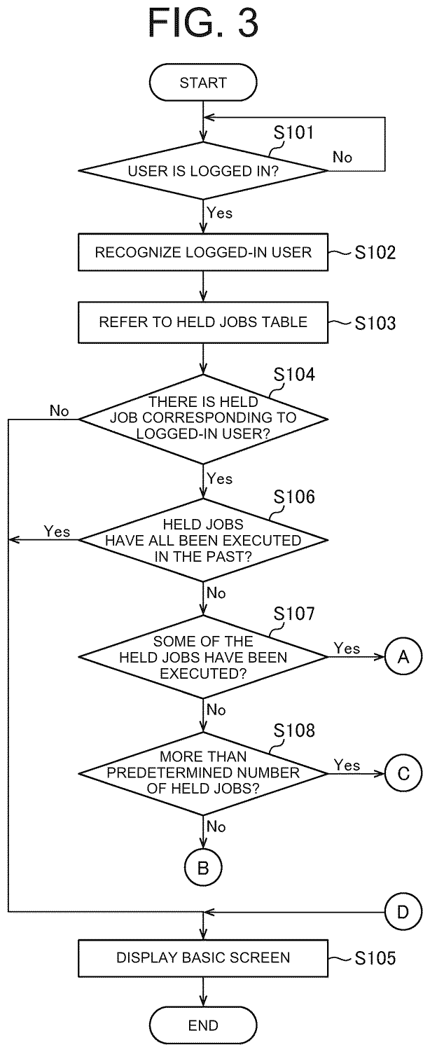

Next, an example of a processing flow of the present embodiment will be explained by referring to various screen examples. FIG. 3 is a flowchart illustrating an example of a processing flow according to the present embodiment. The controller 111 decides whether a user has logged in to the image forming apparatus 101 (step S101). For example, the controller 111 may perform the determination in step S101 on the basis of whether the user has performed a login operation on the operation acceptor 113 and the login has been successful.

If the user has not logged in to the image forming apparatus 101, the controller 111 determines “No” in step S101 and returns the process to step S101. In this case, the controller 111 waits until the user logs in to the image forming apparatus 101.

If the user has logged in to the image forming apparatus 101, the controller 111 determines “Yes” in step S101 and advances the process to step S102. The controller 111 recognizes the user who has logged in (logged-in user) (step S102).

For example, when a user logs in to the image forming apparatus 101 and inputs information about the user (a user name or the like) by using the operation acceptor 113, the logged-in user may be recognized on the basis of the input information about the user. In a case where the image forming apparatus 101 has a function of performing short-range wireless communication, the controller 111 may recognize a logged-in user by the image forming apparatus 101 performing short-range wireless communication with a terminal or the like carried by the user. In this case, the input operation by the user is not necessary.

The controller 111 refers to the held job table T (step S103). At this time, the controller 111 refers to each piece of information corresponding to the user name of the logged-in user recognized in step S102 in the held job table T.

The controller 111 refers to the held job table T and determines whether there is a held job corresponding to the logged-in user (step S104). The controller 111 performs the determination of step S104, for example, on the basis of whether the user name of the logged-in user is included in the item of the user name of the held job table T.

If the held job corresponding to the logged-in user is not in the held job table T, the controller 111 determines “No” in step S104 and advances the process to step S105. For example, if the user name of the logged-in user is “user10,” there is no held job corresponding to the logged-in user in the held job table T of FIG. 2. In this case, the controller 111 determines “No” in step S104.

If “No” is determined in step S104, the controller 111 causes the display 112 to display the basic screen (step S105). After the process of step S105 is completed, the controller 111 ends the flowchart of FIG. 3.

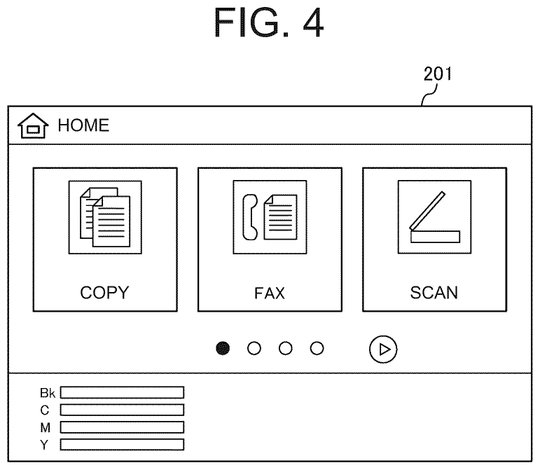

FIG. 4 illustrates an example of a basic screen 201. The basic screen 201 is, for example, an initial screen (home screen) including a copy button, a FAX button, and a scan button. When any one of the buttons is selected, a setting screen for setting a function corresponding to the selected button is displayed. The setting screen may include an execution button (start button) for instructing execution of a function corresponding to the selected button.

As illustrated in the flowchart of FIG. 3, if the controller 111 determines “Yes” in step S104, the process proceeds to step S106. The controller 111 refers to the held job table T and determines whether all print jobs (all held jobs) corresponding to the logged-in user have been executed (step S106). The controller 111 refers to the held job table T and if the item of the presence or absence of the print history for all the print jobs corresponding to the logged-in user indicates “presence,” determines “Yes” in step S106.

For example, it is assumed that the user name of the logged-in user is “user01.” In the held job table T of FIG. 2, the print job corresponding to the user name “user01” is only the print job of the job ID “001,” and the item of the presence or absence of print history of the print job indicates “presence.”

In the above example, when the user name of the logged-in user is “user01,” the item of the presence or absence of print history for all the print jobs corresponding to the logged-in user indicates “presence.” Therefore, the controller 111 determines “Yes” in step S106. In this case, the controller 111 advances the process to step S105.

When all the print jobs corresponding to the logged-in user are resident jobs, such as jobs to be periodically executed and the jobs not to be deleted, the necessity of presenting the logged-in user whether to confirm the execution of the resident jobs is low. Therefore, the controller 111 advances the process to step S105 without displaying various confirmation screens to be described later on the display 112. In this case, the basic screen 201 appears on the display 112.

If it is determined that all the held jobs corresponding to the logged-in user have not been executed, the controller 111 determines “No” in step S106 and advances the process to step S107. The controller 111 refers to the held job table T and determines whether or not some of the print jobs corresponding to the logged-in user have been executed (step S107).

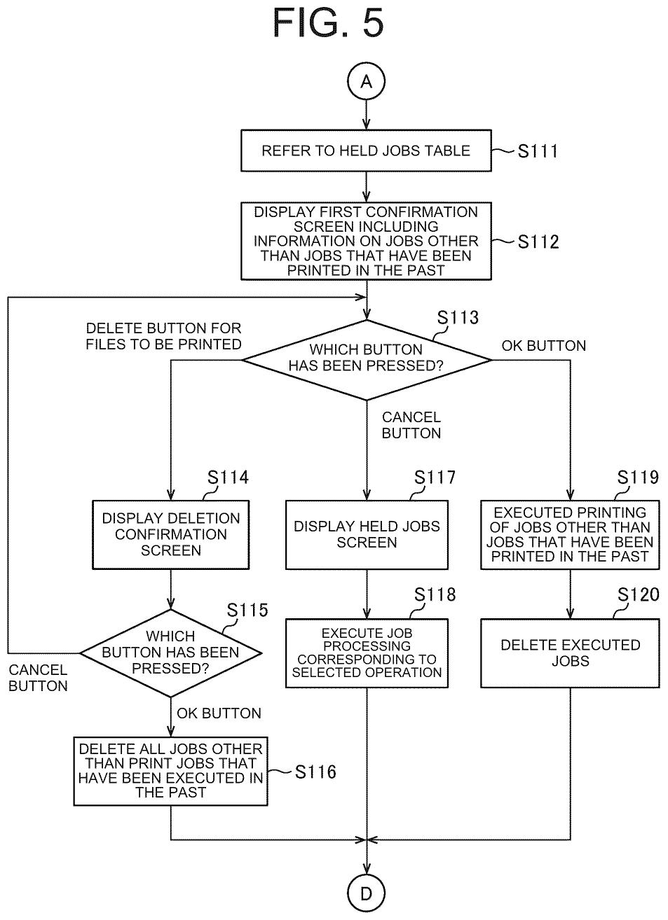

If it is determined that some of the print jobs corresponding to the logged-in user have been executed, the controller 111 determines “Yes” in step S107 and advances the process from “A” to step S111 in FIG. 5. The processes after step S111 will be described later.

For example, it is assumed that the user name of the logged-in user is “user02.” In the held job table T of FIG. 2, the print jobs corresponding to the user name “user02” are three print jobs of the job IDs “002,” “003,” and “004.”

The item of the presence or absence of print history corresponding to the print job of the job ID “002” is “present,” which indicates that the print job has been executed in the past. On the other hand, the item of the presence or absence of the print history corresponding to the two print jobs of the job IDs “003” and “004” is “absence,” which indicates that the two print jobs have not been executed in the past. That is, all of the three print jobs corresponding to the user name “user02” have not been executed, and some of the print jobs have been executed in the past. In this case, the controller 111 determines “Yes” in step S107.

If it is determined that some of the print jobs corresponding to the logged-in user have not been executed, the controller 111 determines “No” in step S107 and advances the process to step S108. When it is determined as No in step S106 and “No” in step S107, all the held jobs corresponding to the logged-in user have not been executed in the past.

For example, it is assumed that the user name of the logged-in user is “user03.” In the held job table T of FIG. 2, the print jobs corresponding to the user name “user03” are multiple print jobs of the job IDs “005” to “025.”

The items of the presence or absence of print history corresponding to the respective print jobs of the job IDs “005” to “025” are all “absence,” and indicate print jobs other than the print jobs executed in the past. That is, it is indicated that all of the print jobs of the job IDs “005” to “025” have not been executed in the past. In this case, the controller 111 determines “No” in step S107.

If “No” is determined in step S107, the controller 111 advances the process to step S108. The controller 111 determines whether the number of held jobs is equal to or greater than a predetermined number (step S108).

As described above, the process of step S108 is executed if “No” is determined in steps S106 and S107. Therefore, the item of the presence or absence of print history corresponding to all the held jobs for which it is determined in step S108 whether the number of held jobs is equal to or greater than a predetermined number is “absence.”

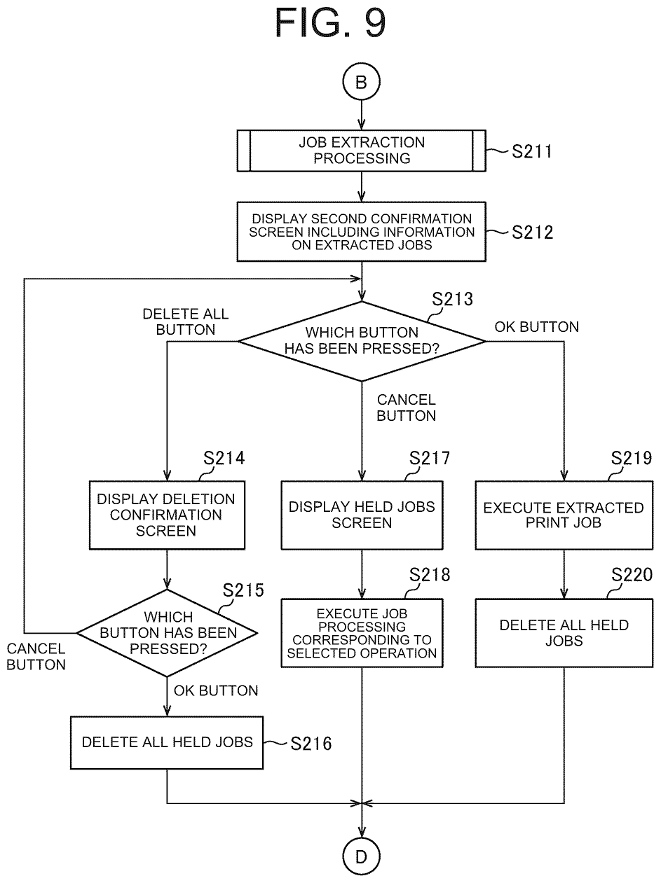

If the number of held jobs to be determined in step S108 is less than the predetermined number, the controller 111 determines “No” in step S108 and advances the process from “B” to step S211 in FIG. 9. The predetermined number serving as a criterion for the determination in step S108 may be any number, and the user can set this to any number.

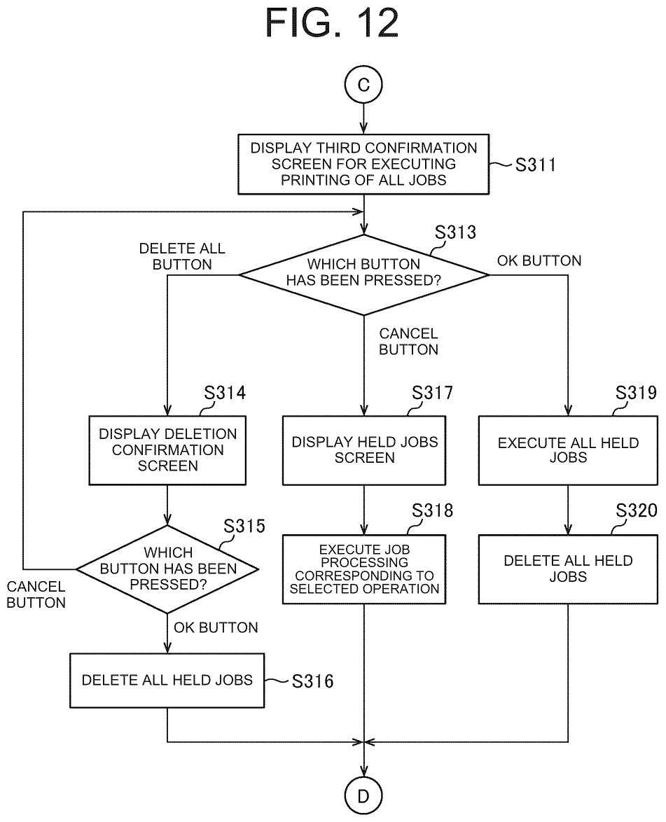

If the number of held jobs to be determined in step S108 is equal to or greater than the predetermined number, the controller 111 determines “Yes” in step S108, and advances the process from “C” to step S311 in FIG. 12. The processes after step S211 and the process of step S311 will be explained later.

Next, an example in which the controller 111 determines “Yes” in step S107 and advances the process from “A” to step S111 in FIG. 5 will be explained. FIG. 5 is a first flowchart continued from FIG. 3.

The controller 111 refers to the held job table T (step S111). The controller 111 causes the display 112 to display a first confirmation screen including information of at least one print job other than the print jobs executed in the past among the held jobs corresponding to the logged-in user (step S112).

For example, it is assumed that the user name of the logged-in user is “user02.” In the held job table T of FIG. 2, among the three print jobs corresponding to the user name “user02,” the print jobs in which the item of the presence or absence of print history indicates “absence” are the two print jobs of the job IDs “003” and “004.”

As described above, the print job in which the item of the presence or absence of print history indicates “absence” is a print job for which it can be estimated that there is a high possibility that the logged-in user intends to execute the printing. The controller 111 acquires the job name “Table 1” corresponding to the job ID “003” and the job name “Table 2” corresponding to the job ID “004” from the held job table T. The controller 111 causes the display 112 to display the first confirmation screen including the acquired job names “Table 1” and “Table 2.”

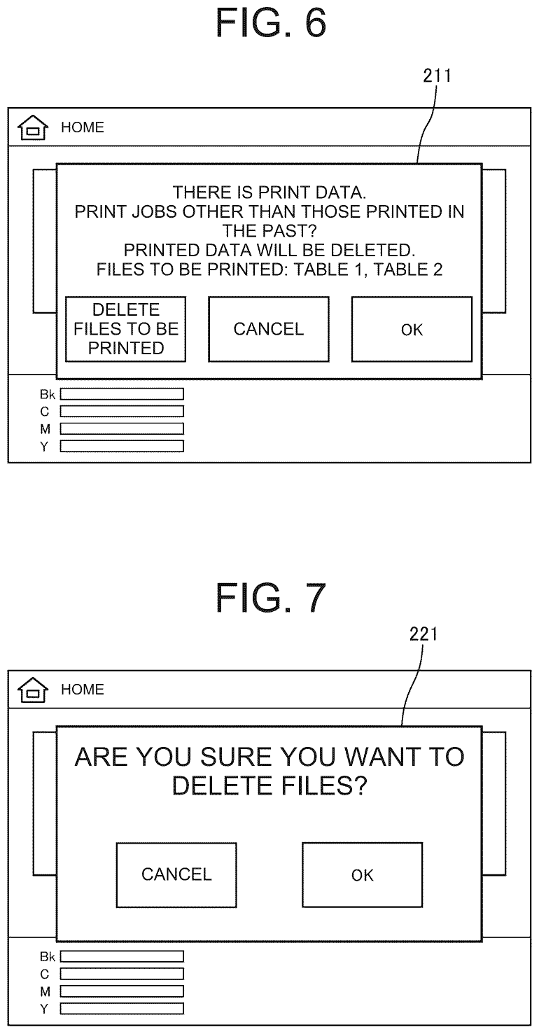

FIG. 6 illustrates an example of a first confirmation screen 211. The first confirmation screen 211 includes an item of a print target file indicating information of the print job to be printed. The first confirmation screen 211 includes a delete button for print target files, a cancel button, and an OK button. The configuration of the first confirmation screen 211 is not limited to the example of FIG. 6.

The first confirmation screen 211 of FIG. 6 is a screen displayed when the user name of the logged-in user is “user02.” In the first confirmation screen 211, “Table 1” and “Table 2” are displayed as the print target files. “Table 1” and “Table 2” are the job names of the print jobs corresponding to the job IDs “003” and “004” described above. The job name represents a file name of a print job.

As described above, the job name displayed in the first confirmation screen 211 as the print target file is a print job for which it can be estimated that there is a high possibility that the logged-in user has intended printing. Therefore, a print job that is highly likely to be a print target can be presented to the logged-in user.

The delete button for print target files in the first confirmation screen 211 is a button for instructing deletion of a print target file. For example, when the delete button for print target files is selected, the controller 111 causes the display 112 to display a deletion confirmation screen (to be described later) and then deletes two print jobs with job IDs “003” and “004” corresponding to “Table 1” and “Table 2,” which are print target files.

The cancel button in the first confirmation screen 211 is a button for instructing to cancel the execution of the print job corresponding to the print target file. For example, when the cancel button is selected, the controller 111 displays a held job screen (to be described later) on the display 112. The OK button in the first confirmation screen 211 is a button for instructing to cancel the execution of the print job corresponding to the print target file. For example, when the OK button is selected, the controller 111 executes two print jobs of job IDs “003” and “004” corresponding to “Table 1” and “Table 2,” which are print target files. As a result, “Table 1” and “Table 2” are printed.

As illustrated in the flowchart of FIG. 5, the controller 111 determines which one of the deletion button for print target files, the cancel button, and the OK button has been selected (step S113).

If the deletion button print target files is selected, the controller 111 advances the process to step S114. In this case, the controller 111 causes the display 112 to display a deletion confirmation screen (step S114).

FIG. 7 illustrates an example of a deletion confirmation screen 221. The deletion confirmation screen 221 of FIG. 7 includes a message for confirming whether to delete the print target file. The deletion confirmation screen 221 includes a cancel button and an OK button. The cancel button in the deletion confirmation screen 221 is a button for instructing cancellation of deletion of a print job corresponding to the print target file (a print job other than print jobs executed in the past), and the OK button in the deletion confirmation screen 221 is a button for instructing deletion of a print job corresponding to the print target file (a print job other than print jobs executed in the past). The controller 111 determines which of the cancel button and the OK button has been selected (step S115).

If it is determined in step S115 that the cancel button has been selected, the controller 111 returns the process to step S113. On the other hand, if it is determined in step S115 that the OK button has been selected, the controller 111 deletes all print jobs other than print jobs executed in the past (step S116). The print job other than the print jobs executed in the past is a print job in which the item of the presence or absence of print history indicates “absence” among the print jobs corresponding to the logged-in user. As described above, the two print jobs of the job IDs “003” and “004” are print jobs other than print jobs executed in the past and are print jobs to be deleted after execution.

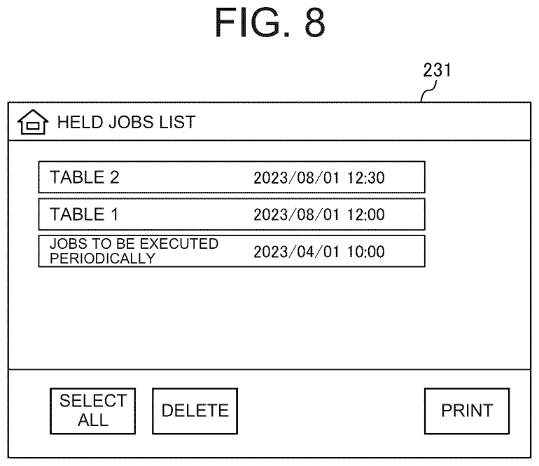

If it is determined in step S113 that the cancel button has been selected, the controller 111 refers to the held job table T and displays the held job screen on the display 112 (step S117). FIG. 8 illustrates an example of the held job screen.

For example, when the logged-in user of the user name “user02” selects the cancel button, there is a possibility that not only “Table 1” and “Table 2” are simply printed but also another operation is performed. Therefore, the controller 111 causes the display 112 to display a held job screen 231 including all held jobs corresponding to the logged-in user.

The controller 111 acquires the job names of all held jobs corresponding to the user name of the logged-in user from the held job table T. At this time, the controller 111 acquires the job names of all held jobs corresponding to the user name of the logged-in user regardless of whether the item of the presence or absence of print history is “presence” or “absence.” This acquires all held jobs corresponding to the logged-in user.

The held job screen 231 in FIG. 8 is a screen displayed when the logged-in user is the user of the user name “user02.” In the held job table T of FIG. 2, information of three print jobs of job IDs “002” to “004” is recorded in correspondence to the user name “user02.” The job names of the three print jobs are “periodically executed job,” “table 1,” and “table 2.”

The controller 111 causes the display 112 to display the held job screen 231 including the job names of the three print jobs with the job IDs “002” to “004.” The logged-in user can perform an operation of selecting printing or deletion for each of the three print jobs included in the held job screen 231 by operating the operation acceptor 113. On the held job screen 231, the logged-in user can perform an operation of selecting printing or deletion of a job including a job to be periodically executed.

The held job screen 231 includes an all select button, a delete button, and a print button. For example, it is assumed that the logged-in user selects “Table 1” on the held job screen 231 and then selects the print button. In this case, the controller 111 deletes the print job after the print job corresponding to “Table 1” is executed.

It is assumed that the logged-in user selects “Table 1” on the held job screen 231 and then selects the delete button. In this case, the controller 111 deletes the print job of “Table 1” and the information of the print job corresponding to “Table 1” from the held job table T. The all select button is a button for collectively selecting all print jobs displayed on the held job screen 231.

As illustrated in the flowchart of FIG. 5, after the process of step S117 is executed, the controller 111 executes job processing corresponding to the operation selected on the held job screen 231 (step S118). The job processing corresponding to the selected operation is the above-described printing or deletion processing.

If the controller 111 determines in step S113 that the OK button has been selected, it advances the process to step S119. The controller 111 executes at least one print job other than the print jobs executed in the past corresponding to the logged-in user with reference to the held job table T (step S119).

At least one print job other than the print jobs executed in the past is a print job in which the item of the presence or absence of print history indicates “absence.” The controller 111 refers to the held job table T and executes the print job in which the item of the presence or absence of print history indicates “absence” among the print jobs corresponding to the logged-in user.

The controller 111 deletes the print job executed in step S119 (step S120). The controller 111 deletes the information of the executed print job from the held job table T.

After the process of step S116, S118, or S120, the controller 111 advances the process from “D” to step S105 in FIG. 3. As a result, the basic screen 201 is displayed on the display 112.

Next, a case where “No” is determined in step S108 of FIG. 3 will be explained. If “No” is determined in step S108, the controller 111 advances the process to step S211 of FIG. 9 from “B.” In this case, the number of held jobs in which the item of the presence or absence of print history corresponding to the logged-in user is “absence” is less than the predetermined number, and the number is small.

FIG. 9 is a second flowchart continued from FIG. 3. The controller 111 executes a job extraction process (step S211). The job extraction process is a process for narrowing down print jobs (target files) to be processed in the flowchart of FIG. 9.

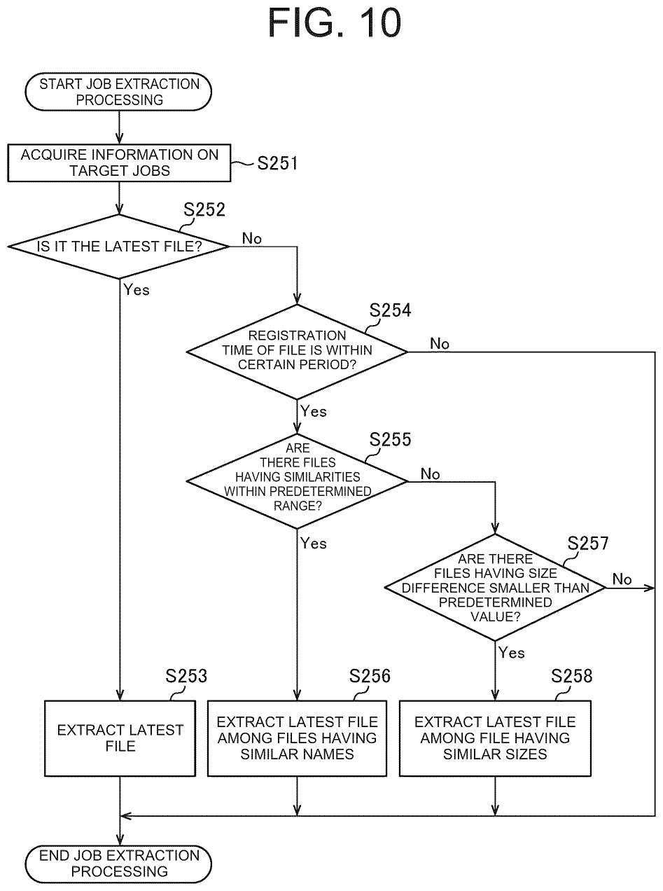

FIG. 10 is a flowchart illustrating an example of the job extraction process. The controller 111 acquires, from the held job table T, the information of the target job corresponding to the print job of which the item of the presence or absence of print history corresponding to the logged- in user is “absence” (step S251). For example, the controller 111 acquires, one by one, multiple print jobs in which the item of the presence or absence of print history corresponding to the logged-in user is “absence” and executes the job extraction processing for all print jobs.

The controller 111 determines whether the target job acquired in step S251 is the latest file (step S252). The controller 111 performs the determination of step S252 with reference to the item of the registration date and time in the held job table T.

Ife the target job is the latest file, the controller 111 determines “Yes” in step S252 and advances the process to step S253. The controller 111 extracts the latest file (step S253). The latest file is a file of a print job which is estimated to have a high possibility that the user intends to print.

If the target job is not the latest file, the controller 111 determines “No” in step S252 and advances the process to step S254. The controller 111 determines whether the registration time of the file of the target job is within a certain period from the current time (step S254). The certain period may be any period or may be set to any period by the user.

When the registration date and time of the file of the target job exceeds a certain period from the current time, it can be estimated that there is a high possibility that the target job is an old print job and the logged-in user does not intend to print the target job. If “No” is determined in step S254, the controller 111 does not extract the target job.

On the other hand, if the registration time of the file of the target job is within a certain period from the current time, the controller 111 determines “Yes” in step S254 and advances the process to step S255. The controller 111 determines whether there is a file of which the degree of similarity of the job name is within a predetermined range among the multiple target jobs (step S255). The predetermined range may be any range and may be set to any range by the user.

In step S255, for example, the controller 111 may perform the determination in step S255 on the basis of whether there is a print job having a degree of similarity within a predetermined range by comparing each print job in which the item of the presence or absence of print history corresponding to the logged-in user is “absence.”

When the determination of step S255 is performed, the controller 111 may calculate the degree of similarity by using, for example, any pattern matching method for the character string of the job name. If there is a file of which the calculated degree of similarity is within the predetermined range, the controller 111 determines “Yes” in step S255. In this case, the controller 111 extracts a file of a target job having the latest registration date and time from among the target jobs having degrees of similarity within a predetermined range (step S256).

If “Yes” is determined in step S255, there are multiple print jobs having the same or similar job name among the print jobs in which the item of the presence or absence of print history corresponding to the logged-in user is “absence.” In step S256, the latest print job is extracted from the print jobs having the same or similar job names. It can be estimated that the extracted latest print job is highly likely to be intended by the user.

If there is no file for which the calculated degree of similarity is within a predetermined range, the controller 111 determines “No” in step S255 and advances the process to step S257. The controller 111 determines whether there is a file (print job) of which the difference in file size (data amount of target job) is equal to or less than a predetermined amount among the target jobs (step S257).

The controller 111 may acquire size information of multiple target jobs that are targets of the determination of step S257 in the held job table T and perform the determination of step S257 on the basis of whether there are print jobs in which the difference in size indicated by the acquired size information is equal to or less than a predetermined amount. The predetermined amount may be set to any amount and may be set to any amount by the user.

If there is a file of which the difference in size is equal to or less than the predetermined amount among the target jobs, the controller 111 determines “Yes” in step S257 and advances the process to step S258. In this case, the controller 111 extracts the file of the target job having the latest registration date and time from among files having a difference in size equal to or smaller than the predetermined amount (step S258). The predetermined amount may be set to any amount.

As described above, if the registration time of the file of the target job is within a certain period from the current time, the controller 111 determines “Yes” in step S254. On the other hand, even if the registration time of the file of the target job is within the certain period from the current time, so long as there is no print job having the same or similar job name and there is no file having a difference in size equal to or smaller than the predetermined amount, the controller 111 does not extract the target job acquired in step S251. In this case, the controller 111 determines “No” in step S257 and ends the job execution processing.

For example, it is assumed that a user whose logged-in user name is “user02” has logged in to the image forming apparatus 101. Moreover, it is assumed that the held job table T records the print job of the job ID “026” corresponding to the user name “user02,” and the registration date and time of the print job is “2023/7/31 12:00.” Moreover, it is assumed that the job name corresponding to the print job having the job ID “026” is “Table 3,” and the item of the presence or absence of print history is “absence.”

The controller 111 acquires, from the held job table T, three print jobs in which the item of the presence or absence of print history indicates “absence” among the print jobs corresponding to the user name “user02” as the target jobs. The three print jobs are print jobs with job IDs “003,” “004,” and “026.”

As described above, in step S253, the controller 111 extracts the latest print job “004” from the three print jobs. It is assumed that the certain period serving as a criterion for the determination in step S254 is, for example, two days, and the current time is “2023/8/1 13:00.” In this case, the controller 111 determines “Yes” in step S254 for the two print jobs with the job IDs “003” and “026.”

The job name of the job ID “003” is “Table 1,” and the job name of the job ID “026” is “Table 3.” For example, in the determination of step S255, it is assumed that the predetermined range serving as a criterion for determining the degree of similarity of job names is a difference of two or more characters. That is, print jobs having the same job name or having a difference of one character are determined to have a degree of similarity within the predetermined range. In the above-described case, since the job names of the job IDs “003” and “026” are different by one character, the controller 111 determines “Yes” in step S255.

The registration date and time of the job ID “003” indicated by the held job table T is “2023/8/1 12:00.” The registration date and time of the print job having the job ID “026” is “2023/7/31 12:00.” Therefore, in step S256, the controller 111 extracts the file of the latest job ID “003” from the two print jobs. In the above case, two print jobs with the job IDs “003” and “004” are extracted as the print jobs corresponding to the user of the user name “user02” as the logged-in user.

After the process of the flowchart of FIG. 10 is executed for all the print jobs for which the item of the presence or absence of print history corresponding to the logged-in user is “absence,” the controller 111 ends the job extraction processing and advances the process of step S212 of FIG. 9. After the job extraction process is executed, the controller 111 causes the display 112 to display the second confirmation screen including information of the extracted print jobs (step S212).

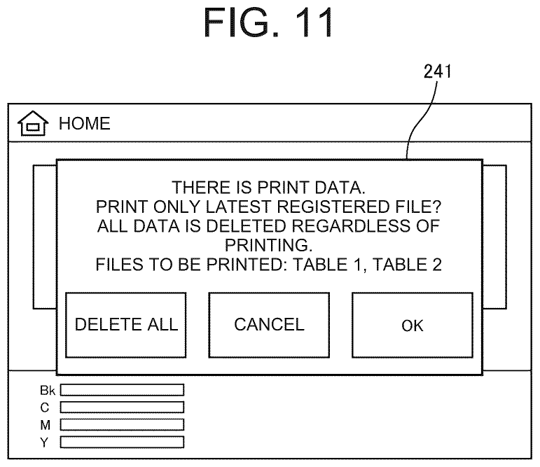

FIG. 11 illustrates an example of a second confirmation screen 241. The second confirmation screen 241 includes an item of a print target file indicating a print job of a print target. The second confirmation screen 241 includes a delete all button, a cancel button, and an OK button. The configuration of the second confirmation screen 241 is not limited to the example of FIG. 11.

The second confirmation screen 241 of FIG. 11 is an example screen displayed when the user name of the logged-in user is “user02.” In the second confirmation screen 241, “Table 1” and “Table 2” are displayed as the print target files. “Table 1” and “Table 2” are the job names of the two print jobs of the job IDs “003” and “004” extracted through the above-described job extraction processing.

The print job extracted in the job extraction processing is a new print job. The new print job is a print job that is estimated to be highly likely to have been printed by the logged-in user. Therefore, the print job to be a print target can be presented to the user.

Each print job extracted in the job extraction processing is a print job corresponding to “absence” in the item of the presence or absence of print history. Therefore, the second confirmation screen 241 includes a message indicating that all print jobs (data) are to be deleted after printing is executed.

As illustrated in the flowchart of FIG. 9, the controller 111 advances the process to step S212 after the process of step S213 is executed. The controller 111 determines which of the delete all button, the cancel button, and the OK button has been selected (step S213).

The delete all button in the second confirmation screen 241 is a button for instructing deletion of all held jobs corresponding to the logged-in user. For example, if the delete all button is selected, the controller 111 advances the process to step S214. In this case, the controller 111 causes the display 112 to display the deletion confirmation screen 221 of FIG. 7 (step S214).

If it is determined that the cancel button is selected on the deletion confirmation screen 221, the controller 111 returns the process to step S213. On the other hand, if it is determined that the OK button has been selected on the deletion confirmation screen 221, the controller 111 deletes all held jobs corresponding to the logged-in user (step S216).

The cancel button in the second confirmation screen 241 is a button for instructing to cancel the execution of the print job corresponding to the print target file and the deletion of all held jobs corresponding to the logged-in user. If it is determined in step S213 that the cancel button in the second confirmation screen 241 has been selected, the controller 111 refers to the held job table T and causes the display 112 to display the held job screen 231 in FIG. 8 (step S217).

After the process in step S217 is executed, the controller 111 executes job processing corresponding to the operation selected on the held job screen 231 (step S218). The OK button in the second confirmation screen 241 is a button for instructing the execution of the print job corresponding to the print target file and the deletion of all held jobs corresponding to the logged-in user. In step S213, if the controller 111 determines that the OK button in the second confirmation screen 241 is selected, the controller 111 refers to the held job table T and executes all extracted print jobs among all held jobs corresponding to the logged-in user (step S219).

The controller 111 deletes all held jobs corresponding to the logged-in user (step S220). After the process of step S216, S218, or S220 is executed, the controller 111 advances the process from “D” to step S105 in FIG. 3. As a result, the basic screen 201 is displayed on the display 112.

Next, a case where the determination in step S108 of FIG. 3 is “Yes” will be explained. In this case, the number of held jobs is equal to or larger than a predetermined number, and the number is large. When the number of held jobs is large, the logged-in user needs to perform an operation of printing or deleting print jobs while checking the print jobs one by one, which makes the operation complicated. In this case, it is assumed that the logged-in user is less likely to select whether to execute or delete the held job. If the number of held jobs is large, it may be difficult to display information of all print jobs on the display 112.

Therefore, the controller 111 causes the display 112 to display a third confirmation screen including a message requesting confirmation of whether or not to simply execute the held jobs, and buttons to be operated. The third confirmation screen will be described later.

If it is determined as Yes in step S108 of FIG. 3, the controller 111 causes the process to proceed from “C” to step S311 of FIG. 12. FIG. 12 is a third flowchart continued from FIG. 3.

As illustrated in the flowchart of FIG. 12, the controller 111 causes the display 112 to display the third confirmation screen for executing all print jobs corresponding to the logged-in user (step S311).

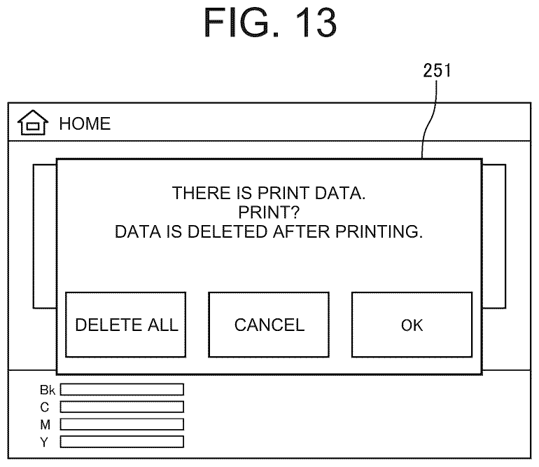

FIG. 13 illustrates an example of a third confirmation screen 251. The third confirmation screen 251 does not include information of a print target file but simply includes a message requesting confirmation of whether or not to execute held jobs. As illustrated in the flowchart of FIG. 12, the controller 111 determines which one of the delete all button, the cancel button, and the OK button has been selected (step S313).

If the delete all button is selected, the controller 111 advances the process to step S314. In this case, the controller 111 causes the display 112 to display the deletion confirmation screen 221 of FIG. 7 (step S315).

If it is determined that the cancel button is selected on the deletion confirmation screen 221, the controller 111 returns the process to step S313. On the other hand, if it is determined that the OK button has been selected on the deletion confirmation screen 221, the controller 111 deletes all print jobs corresponding to the logged-in user (step S316).

The cancel button in the third confirmation screen 251 is a button for instructing cancellation of execution of the print job and deletion of data after printing. If it is determined in step S313 that the cancel button in the third confirmation screen 251 has been selected, the controller 111 refers to the held job table T and causes the display 112 to display the held job screen 231 in FIG. 8 (step S317). After the process in step S317 is executed, the controller 111 executes job processing corresponding to the operation selected on the held job screen 231 (step S318).

The OK button in the third confirmation screen 251 is a button for instructing execution of the print job and deletion of data after printing. In step S313, if the controller 111 determines that the OK button in the third confirmation screen 251 is selected, the controller 111 executes all held jobs corresponding to the logged-in user with reference to the held job table T (step S319).

The controller 111 deletes all held jobs executed in step S319 (step S320). After the process of step S316, S318, or S320 is executed, the controller 111 advances the process from “D” to step S105 in FIG. 3. As a result, the basic screen 201 is displayed on the display 112.

As described above, in the present embodiment, when some of the held jobs corresponding to the logged-in user have been executed in the past, the controller 111 causes the display 112 to display the first confirmation screen 211 including information indicating at least one held job other than the some held jobs. It can be estimated that there is a high possibility that a held job that has not been executed in the past is not a resident job but a print job that the logged-in user intends to print. In the present embodiment, by displaying the held job that has not been executed in the past on the display 112, a print job for which it can be estimated that there is a high possibility that the logged-in user has intended to print can be presented to the logged-in user.

### Other

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image forming apparatus comprising:
a display; and
one or more controllers,
wherein the one or more controllers
refer to first information associating user identification information identifying a user with print history information indicating presence or absence of print histories related to print jobs held by the image forming apparatus, and
control, on a basis of whether the print history information corresponding to the user identification information of a logged-in user who is logged in to the image forming apparatus indicates the presence of a print history of some of the print jobs, whether to cause a first confirmation screen including information indicating at least one print job other the some of the print jobs to appear on the display.

2. The image forming apparatus according to claim 1, wherein the some of the print jobs are resident jobs residing in the image forming apparatus.

3. The image forming apparatus according to claim 2, wherein the resident jobs are print jobs of which printing is performed periodically or print jobs set to not be deleted.

4. The image forming apparatus according to claim 1, wherein the one or more controllers
refer to the first information, and
cause, when the print history information corresponding to the user identification information of the logged-in user indicates that no print history is present for all of the print jobs and the number of print jobs corresponding to the user identification information of the logged-in user held by the image forming apparatus is fewer than a predetermine number, a second confirmation screen including information indicating one or more print jobs satisfying a predetermined condition among the print jobs fewer than the predetermined number to appear on the display.

5. The image forming apparatus according to claim 4, wherein the predetermined condition is the latest print job among the print jobs corresponding to the logged-in user held by the image forming apparatus.

6. The image forming apparatus according to claim 4, wherein the one or more controllers
eliminate a print job of which a certain period has passed from a current time among the print jobs corresponding to the logged-in user held by the image forming apparatus from a print target because the print job does not satisfy the predetermined condition.

7. The image forming apparatus according to claim 4, wherein when a plurality of print jobs among the print jobs fewer than the predetermined number have a degree of job name similarity within a predetermined range, the predetermined condition is the latest print job among the print jobs within the predetermined range.

8. The image forming apparatus according to claim 4, wherein when a plurality of print jobs among the print jobs fewer than the predetermined number have a size difference within a predetermined amount, the predetermined condition is the latest print job among the print jobs within the predetermined amount.

9. A method of controlling an image forming apparatus including a display, the method comprising:
referring to first information associating user identification information identifying a user with print history information indicating presence or absence of print histories related to print jobs held by the image forming apparatus; and
controlling, on a basis of whether the print history information corresponding to the user identification information of a logged-in user who is logged in to the image forming apparatus indicates the presence of a print history of some of the print jobs, whether to cause a first confirmation screen including information indicating at least one print job other the some of the print jobs to appear on the display.
